(19) United States
(12) Patent Application Publication
(10) Pub. No.: US 2018/0275407 A1
(43) Pub. Date: Sep. 27, 2018

(54) Optical systems in see-through display devices

(71) Applicant: Panovision Co. Ltd. (1-2017-010515-3), Seongnam-si (KR)

(72) Inventors: Jangho Choi, Suzhou (KR); Jin Soo Kim, Gyeonggi-do (KR); Darwin Hu, San Jose, CA (US)

(21) Appl. No.: 15/905,054

(22) Filed: Feb. 26, 2018

(30) Foreign Application Priority Data
Mar. 21, 2017 (KR) 10-2017-0035243

(51) Int. Cl. G02B 27/01; G02B 27/00; F21V 8/00

(52) U.S. Cl. CPC G02B 27/0172; G02B 27/0081; G02B 2027/0123; G02B 6/0016; G02B 6/0028; G02B 6/0076

(57) ABSTRACT

Techniques related to a see-through optical system are disclosed. According to one aspect of the techniques, the optical system includes a lens unit for enlarging an image light displayed on a display panel, a horizontal light guide includes an inclined plane of a sawtooth shape to totally reflect the enlarged image light and expand an exit pupil distance along a horizontal direction, a vertical light guide placed under the horizontal light guide to totally reflect the enlarged image light transferred from the horizontal light guide to expand the exit pupil distance in a vertical direction. Optionally, a compensation prism for reflecting the image light with the exit pupil distance expanded in both horizontal and vertical directions is used.

### BACKGROUND OF THE INVENTION

### Field of the Invention

The present invention is related to optical designs in see-through display devices (e.g., display glasses or head mount display (HMD)). More specifically, the present invention relates to an optical system using vertical and horizontal light waveguides to expand an exit pupil distance, thus significantly expanding its applications in the display devices by reducing the volume and weight while improving convenience for wearers.

### Background of the Related Art

A head mount display (HMD) refers to a device for enlarging and seeing a virtual image originated from a high-definition micro display arranged right before the eyes through an optical system. Such a wearable device is referred to as a see-closed HMD if all directions of the HMD are blocked and only the virtual image provided is seen, and referred to as a see-through HMD if a wearer sees simultaneously a virtual image and a scene external to the HMD, typically in front of the eyes and overlapped with each other.

The distance between the pupils of two eyes varies from one user to another user. An HMD optical system needs a range for providing the same image to both eyes so as to be a commercially useful product. Defined as an exit pupil distance, the distances between the pupils on different users are different. Although some users may conveniently see a virtual screen without noticing the image being cut as the exit pupil increases, an unfit distance may cause the discomfort for many other users. If the exit pupil distance is increased to assist a general optical system in the HMD, the usability thereof may be lowered as the size or thickness of the optical system placed in front of the eyes of a user increases. Particularly, in the case of a see-through HMD, when reducing the volume and weight of the optical system, the exit pupil distance and the size of a virtual screen are reduced. Thus there is a need to provide a see-through HMD optical system convenient to wearers by reducing the volume and weight while providing an appropriate virtual screen size a see-through HMD.

Various techniques for providing an image before the eyes of a wearer have been introduced. FIG. 1 shows one way of naturally getting a beam out of a light guide by placing an inclined plane which obliquely crosses the light guide and putting a reflective coating on part or all of the surface, as further detailed in Korean Patent Registration No. KR100449704. As shown in FIG. 1, a virtual screen provided to a user is divided as many times as the number of total reflections occurring in a light guide, transferred along a path within the material of the light guide, and is reflected by the inclined plane arranged inside the light guide in front of the eyes of the wearer to transfer the image to the pupils. However, since such a method expands an exit pupil distance only for a horizontal or vertical direction of a virtual image, the size of the virtual screen can be increased only in one direction. Another example of increasing the size of a virtual screen and expanding an exit pupil distance in a see-through HMD optical system is shown in FIG. 2 and further detailed in Korean Patent Registration No. KR100839574.

FIG. 2 shows an optical system for expanding the size of a virtual screen by placing a plurality of inclined planes into a light guide in order to increase the image size of the virtual screen before the pupils of the user. Through one of the inclined planes, an image at the point (from a corresponding included plane) in front of the eyes is seen. Although such a method provides a means for increasing the image size of a virtual screen, the exit pupil expansion is achieved only for a single direction and its usability is very limited. In addition, a different coating means for outputting an image light has to be provided separately and very precise bonding is required.

There is yet another need for a see-through HMD optical system capable of minimizing the volume and weight while having the exit pupil expansion in all directions as well as having a sufficient virtual screen.

### SUMMARY OF THE INVENTION

This section is for the purpose of summarizing some aspects of the present invention and to briefly introduce some preferred embodiments. Simplifications or omissions in this section as well as in the abstract and the title may be made to avoid obscuring the purpose of this section, the abstract and the title. Such simplifications or omissions are not intended to limit the scope of the present invention.

One of the objects of the present invention is to provide a user with a see-through optical system having both horizontal and vertical exit pupil expansion means. More specifically, an object of the present invention is to provide a see-through optical system that may be used in HMD or other wearable devices. Such optical designs can sufficiently secure a distance between eyes of a wearer.

According to one aspect of the implementation of the present invention, The exit pupil distance is expanded in both horizontal and vertical directions, where the vertical exit pupil distance is expanded by a light guide for the vertical direction and the horizontal exit pupil distance is expanded by a light guide of the horizontal direction. The light guides are so integrated to allow a wearer to simultaneously see a virtual image and an external scene. Further the optical design contemplated in one embodiment of the present invention may enhance the usability of the display devices employing the designs and while significantly reducing the volume and weight.

The present invention may be implemented as an apparatus, a method, a part of system. Different implementations may yield different benefits, objects and advantages. In one embodiment, the present invention is a see-through optical system for expanding both horizontal and vertical exit pupil distances, the optical system comprises: a horizontal light guide having an inclined plane and a reflection plane with a sawtooth structure; a lens unit for collecting an image light displayed on a display panel and optically enlarging the image light, the lens unit impinging the enlarged image light upon the inclined plane, wherein the enlarged image light propagates within the horizontal light guide bounded by the sawtooth structure based on total reflections to increase an exit pupil distance along a horizontal direction. The optical system further comprises a vertical light guide, disposed under the horizontal light guide, receiving the enlarged image from the horizontal light guide, expanding the exit pupil distance along a vertical direction.

In another embodiment, the optical system further comprises a compensation prism integrated with the vertical light guide to make the vertical light guide look like a regular lens, wherein the image light is seen in the vertical light guide while an external scene is also viewed through the vertical light guide. The horizontal light guide has another inclined plane at one end thereof, the compensation prism is integrated with the horizontal light guide at the another inclined plane.

In yet another embodiment, the sawtooth structure includes a plurality of reflection areas, a notch is disposed between two adjacent sawteeth, each of the reflection areas reflects a portion of the enlarged image light towards the vertical light guide.

There are many other objects, together with the foregoing attained in the exercise of the invention in the following description and resulting in the embodiment illustrated in the accompanying drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1 shows an example of a conventional technique of configuring a see-through HMD optical system using a general light guide;

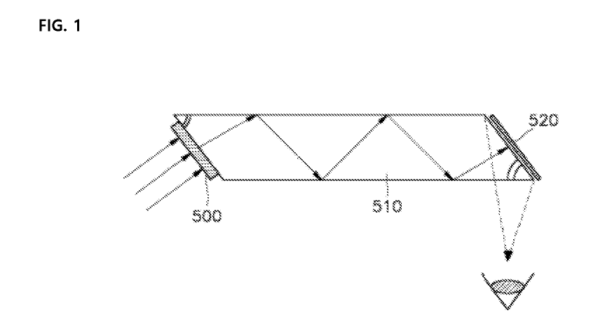

FIG. 2 shows another example of a conventional technique of configuring a see-through HMD optical system using a general light guide having a plurality of inclined planes, each reflecting beams of different polarization angles;

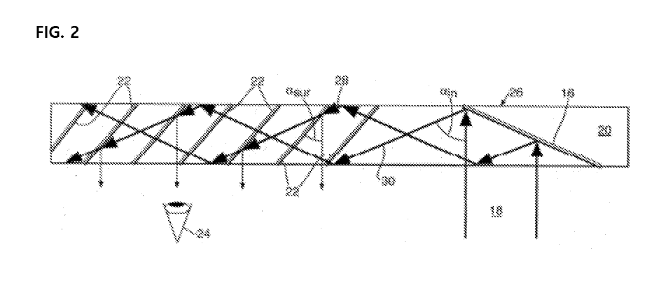

FIG. 3 shows an exemplary optical design employing both horizontal and vertical exit pupil expansion mechanism according to one embodiment of the present invention;

FIGS. 4A, 4B and 4C show, respectively, an inclined plane of a light guide and a sawtooth structure arranged on the surface of a light guide to expand an exit pupil distance of the horizontal direction according to one embodiment of the present invention;

FIG. 5 is a view describing propagation of a beam within a light guide for expanding an exit pupil distance in the vertical direction according to one embodiment of the present invention;

FIGS. 6A and 6B show respectively an exemplary implementation of a see-through HMD optical system for expanding exit pupil according to one embodiment of the present invention;

FIG. 7 shows still another exemplary implementation of a see-through HMD optical system for expanding the exit pupil according to one embodiment of the present invention; and

FIG. 8 shows an exemplary configuration of an optical system using a compensation prism on an inclined plane for augmented reality (AR) that can simultaneously see a virtual screen and an external scene on a lens in an HMD according to one embodiment of the present invention.

### DETAILED DESCRIPTION OF THE INVENTION

In the following description, numerous specific details are set forth to provide a thorough understanding of the present invention. The present invention may be practiced without these specific details. The description and representation herein are the means used by those experienced or skilled in the art to effectively convey the substance of their work to others skilled in the art. In other instances, well-known methods, procedures, components, and circuitry have not been described in detail since they are already well understood and to avoid unnecessarily obscuring aspects of the present invention.

Reference herein to “one embodiment” or “an embodiment” means that a particular feature, structure, or characteristic described in connection with the embodiment can be included in at least one implementation of the invention. The appearances of the phrase “in one embodiment” or “in the embodiment” in various places in the specification are not necessarily all referring to the same embodiment, nor are separate or alternative embodiments mutually exclusive of other embodiments. As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

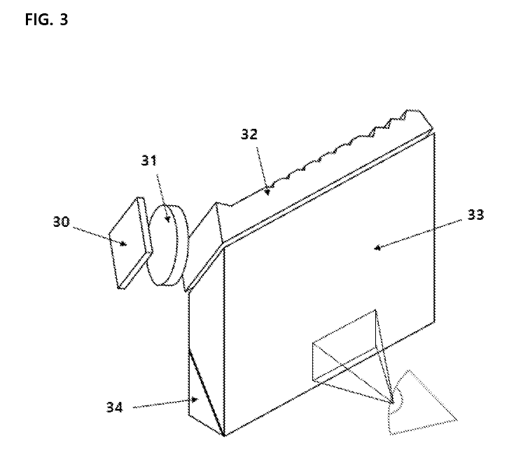

Embodiments of the present invention are discussed herein with reference to FIGS. 3-8. However, those skilled in the art will readily appreciate that the detailed description given herein with respect to these figures is for explanatory purposes only as the invention extends beyond these limited embodiments.

Referring now to the drawings, in which like numerals refer to like parts throughout the several views, FIG. 3 shows an optical system employing both horizontal and vertical exit pupil expansion mechanisms according to one embodiment of the present invention. The mechanism may be advantageously used in a see-through wearable display device such as a head mount display (HMD) or a pair of display glasses.

As shown in FIG. 3, there is a display panel 30 is disposed near an optical system. One example of the display panel 30 is LCoS that displays an image thereon. The optical system includes a lens unit 31 for picking up the displayed image from the display panel 30 and optically enlarging the image, a horizontal light guide 32, a vertical light guide 33 placed under the horizontal light guide 32 and a compensation prism 34. Specifically, the horizontal light guide 32 patched to the vertical light guide 33 makes the vertical light guide 32 look like a flat glass. Through the optical system, a wearer may simultaneously see an enlarged virtual image through the vertical light guide 33 and an external scene also through the vertical light guide 33 without optical distortion.

To reflect the enlarged image transferred from the lens unit 31 within the material, the vertical light guide 33 is placed under the horizontal light guide 32 to receive and the enlarged image transferred from the horizontal light guide 32 within the material and expand the exit pupil distance in the vertical direction. According to one embodiment, the compensation prism 33 is patched to the vertical light guide 33 to make the vertical light guide 33 a flat glass so that a user may simultaneously see the enlarged projected image and an external image without distortion. In one embodiment, the horizontal light guide 32 is designed to have an inclined surface or plane on which an array of saw teeth is provided to expand an exit pupil distance in the horizontal direction.

In one embodiment, the display panel 30 is a display having a micro pixel element implementing a high resolution in the light emitting area of one inch or smaller and may exist in various forms such as an LCD, an LCOS, an OLED, a DMD and the like. The lens unit 31 includes one or more lenses or modules and performs a function of focusing and enlarging a displayed image captured from the display panel 30 by a predefined magnification and projects the enlarged image to the horizontal light guide 32. The image is enlarged as the focal point of the lens unit 31 is formed by changing the propagation path of a beam according to the refractive index of a material by changing the incident angle of the image on the surface of a transparent glass or plastic material having a curvature.

The surface of the horizontal light guide 32 has a sawtooth structure that transfers an image by reflecting the image based on the Total Internal Reflection (TIR) principle that an image light propagates within a material at an angle relative to a critical angle or higher and does not pass through the surface of the material. The image is reflected in a divided form by the sawtooth structure, comes out to the outside of the horizontal light guide 32 and is immediately transferred into the vertical light guide 33.

The vertical light guide 33 transfers the image by dividing the image in a method of varying the number of reflections to expand the exit pupil distance of the vertical direction and emits the image (light) from the vertical light guide 33 to the outside using a finally arranged inclined plane near the end of the vertical light guide 33 to transfer the image light to the eyes of the user.

According to one embodiment, the inclined plane of the vertical light guide 33 may use a method such as a mirror coating, a half-mirror coating, a polarized coating, a polarized film or the like to reflect part of all of the image into the eyes.

The compensation prism 34 has a corresponding inclined plane to the inclined plane of the vertical light guide 33. When the inclined plane of the compensation prism 34 and the inclined plane of the vertical light guide 33 are attached in a form adhering to each other, the user can simultaneously see an enlarged virtual image outputted from the vertical light guide 33 and an external view without optical distortion.

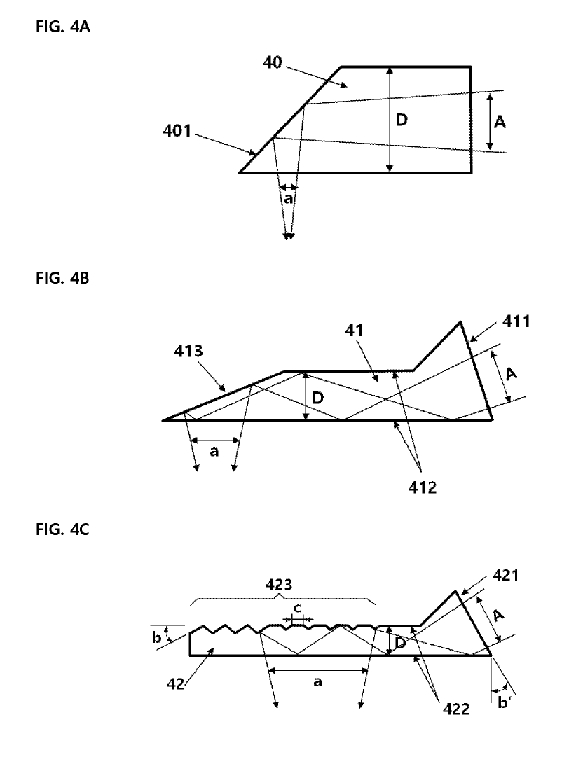

FIGS. 4A, 4B and 4C shows respectively views comparing and describing an example of an inclined plane of a light guide and a sawtooth structure arranged on the surface of a light guide to expand an exit pupil distance along the horizontal direction according to one embodiment of the present invention.

As shown in FIG. 4A, an angle of an exemplary inclined plane 401 for transferring an image light without segmenting a screen in a general light guide 40 is forty-five degrees and the surface total reflection is not used. Thus the thickness of the light guide increases, and the volume and weight of the optical system can increase significantly.

As shown in FIG. 4B, a light guide 41 is used to segment a screen and transfer an image light by varying the number of reflections. The light guide 41 is shaped with an incident plane 411 having a slope, a total reflection plane 412 and an inclined plane 413, where the image light is impinged upon the incident plane 411 and propagates within the light guide 41 through the total reflection plane 412 and finally comes out of the light guide 41 through the inclined plane 413.

As shown in FIG. 4C, a light guide 42 having a sawtooth structure arranged on the surface thereof to expand an exit pupil distance in the horizontal direction is shaped with an incident plane 421 having a slope, a total reflection plane 422 and an inclined plane 423 of a sawtooth structure, wherein the image light is impinged upon the incident plane 421 and propagates within the light guide 42 through the total reflection plane 422 and finally comes out of the light guide 42 through the inclined plane 423 of the sawtooth structure.

Comparing FIGS. 4A, 4B and 4C, the method of segmenting a screen as shown in FIG. 4B uses the space more effectively than the method that does not segment a screen as shown in FIG. 4A as the thickness D is smaller in transferring an enlarged image of the same size A. Compared with the method of FIG. 4B, the method of FIG. 4C may reduce the thickness and increase the size of the exit pupil distance of the horizontal direction in transferring an enlarged image of the same size.

In one embodiment, the surface of the inclined plane 423 where the image light is reflected in the light guide 42 has a sawtooth structure and reflectively coated. The image light colliding with the inclined plane 423 is totally reflected, and the angle b of the inclined plane is the same as the inclined angle b′ of the incident plane 421 through which the image light is impinged into the horizontal light guide 42.

In addition, a distance c between the saw-teeth is specified in the sawtooth structure on the light guide 42 so that part of the beam may be reflected and part of the beam may be totally reflected and continuously propagate for expansion of an exit pupil distance along the horizontal direction. In general, the distance c between the saw-teeth may not exceed 2 mm, which is the minimum size of a pupil. As a result, some of the image light will enter into the pupil of a person even when the pupil is shrunk to the minimum.

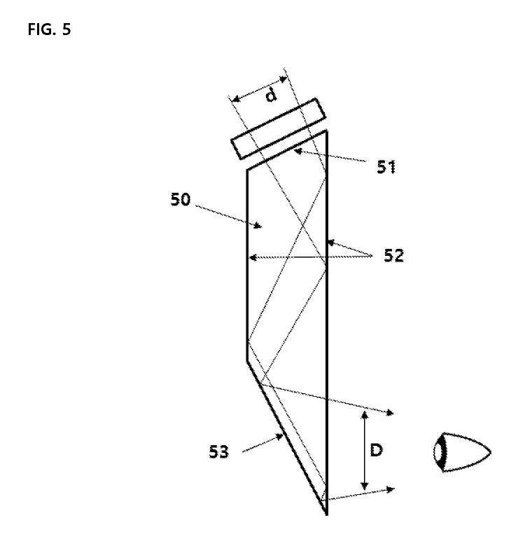

FIG. 5 is a side view describing the propagation direction of a beam in a light guide for expanding an exit pupil distance along the vertical direction according to one embodiment of the present invention. As shown in FIG. 5, a light guide 50 for expanding an exit pupil distance along the vertical direction is made of or shaped with an incident plane 51, a total reflection plane 52 and an inclined plane 53. An image light is obliquely impinged upon the incident plane 51 and propagates inside the light guide 50 within the total reflection plane 52, finally comes out of the light guide 50 through the inclined plane 53 and is transferred to the pupil of the user.

At this point, comparing the width d of an incoming enlarged image light and the width D of an outgoing enlarged image light, it is understood that although the image light has travelled a predetermined distance through the light guide 50, the width D of the outgoing enlarged image light is increased to be larger than the width d of the incoming enlarged image light, and this is a result obtained by varying the number of reflections by segmenting the screen.

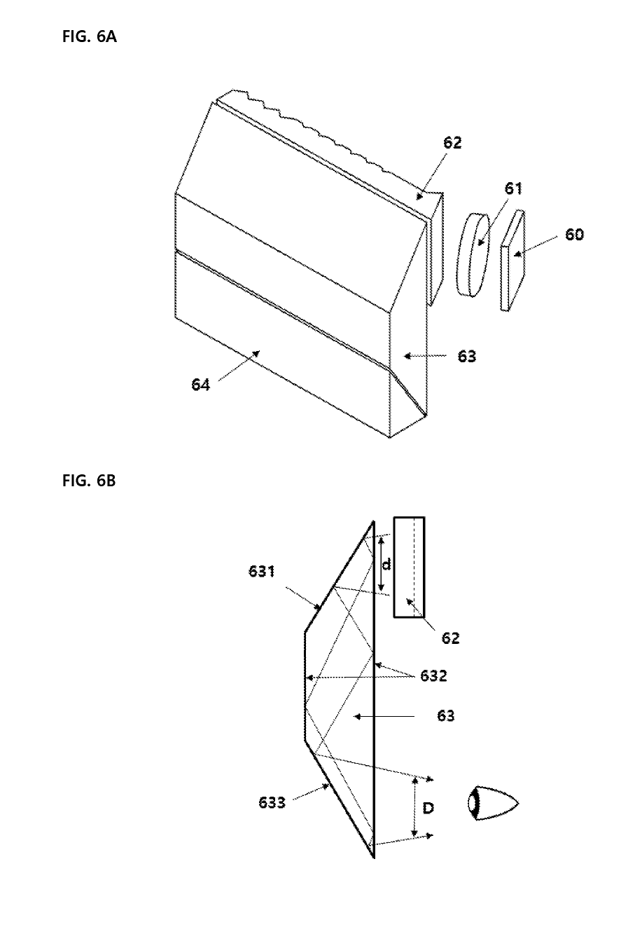

FIGS. 6A and 6B are views showing another example of using a see-through optical system having horizontal and vertical exit pupil expansion means. As shown in FIG. 6A, a see-through HMD optical system includes a display panel 60, a lens unit 61 for enlarging an image displayed on the display panel, a horizontal light guide 62 for totally reflecting the enlarged image coming from the lens unit 61 within the material and arranging an inclined plane of a sawtooth structure to expand an exit pupil in the horizontal direction, a vertical light guide 63 placed in front of the horizontal light guide 62 to receive and reflect the enlarged image from the horizontal light guide 62 within the material and expand the exit pupil in the vertical direction, and a compensation prism 64 patched to the vertical light guide 63 to make the vertical light guide a flat glass so that a user may simultaneously view an enlarged virtual image through the vertical light guide 63 and see an external scene without a distortion. The display panel 60, the lens unit 61 and the horizontal light guide 62 are the same as those of the embodiment presented in FIG. 3.

The vertical light guide 63 shown in FIG. 6B is different from the embodiment presented in FIG. 3 in the method of inputting an image light into the vertical light guide 63 and is configured of a first reflection plane 631, a total reflection plane 632 and a second reflection plane 633. The vertical light guide 63 is placed on the front side of the horizontal light guide 62 to reflect the image light transferred from the horizontal light guide 62 by the first reflection plane 631, and since the propagation path of the reflected beam is the same as that of the embodiment of FIG. 3, an effect of reducing the volume of the top portion of the optical system can be obtained. According to one embodiment, the reflection planes are so arranged that the inclination angle of the first reflection plane 631 is the same as the inclination angle of the second reflection plane 633.

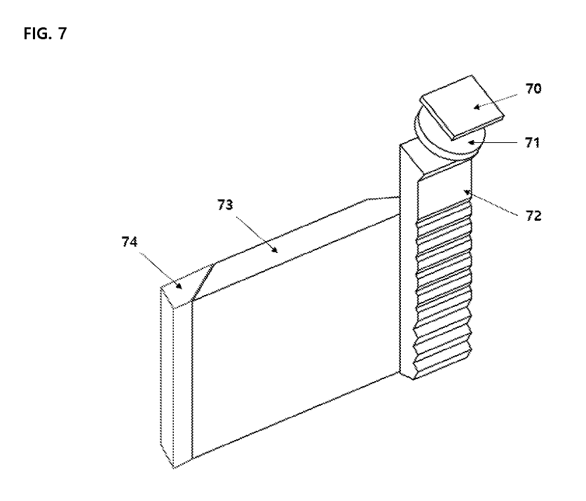

FIG. 7 shows another embodiment having a sawtooth structure on another light waveguide. As shown in FIG. 7, a see-through optical system includes a display panel 70, a lens unit 71 for enlarging an image displayed on the display panel 70, a vertical light guide 72 for totally reflecting the enlarged image transferred from the lens unit 71 within the material and expanding an exit pupil in the vertical direction, where the vertical light guide 72 is shaped with an inclined plane on which the surface shows a sawtooth structure. A horizontal light guide 73 placed in front of the vertical light guide 72 to receive and totally reflect the enlarged image transferred from the vertical light guide 72 within the material and expand the exit pupil in the horizontal direction. A compensation prism 74 is patched to the horizontal light guide 73 to make the horizontal light guide like a flat glass so that a user may simultaneously see the enlarged virtual image through the horizontal light guide 73 and an external view at the same time without optical distortion.

The embodiment presented in FIG. 7 is a structure of changing the roles of the light guides of the vertical direction and the horizontal direction by changing the direction of inducing the image light in the embodiment presented through FIGS. 6A and 6B. Although the principle and the method of expanding an exit pupil are the same, a structure interfering the field of view does not exist at all in the upper and lower portions of the horizontal light guide 73, a frame may be configured like general glasses.

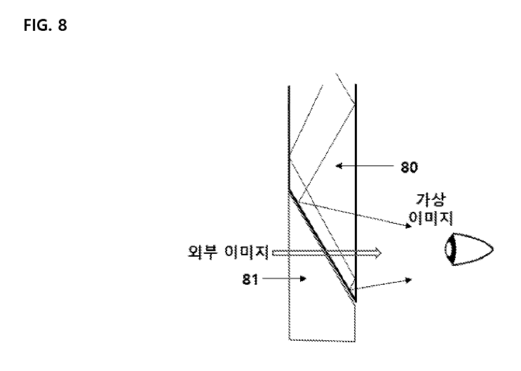

FIG. 8 is a view showing an optical system additionally attaching a compensation prism on an inclined plane to implement augmented reality which can simultaneously secure a virtual screen and an external image on a final HMD output surface applied to the present invention.

As shown in FIG. 8, an optical system capable of simultaneously securing a virtual screen and an external image includes a vertical or horizontal light guide 80 and a compensation prism 81 for transmitting the external image without a phase distortion by compensating the vertical or horizontal light guide. According to the configuration, augmented reality can be implemented as the virtual screen and the external image can be secured simultaneously.

The present invention may provide a user with a see-through optical system having a horizontal and vertical exit pupil expansion means. More specifically, the present invention provides a see-through optical system that sufficiently secures a distance between the eyes of a user and a final output surface by a vertical exit pupil distance expanded by a light guide along the vertical direction provided together with a horizontal exit pupil distance expanded by a light guide along the horizontal direction. As a result, an HMD employing one embodiment of the optical system in the present invention may significantly enhance the usability of the HMD and may extend the HMD into other application fields with reduced volume and weight.

The effects that can be obtained from the present invention are not limited to the effects mentioned above, and unmentioned other effects may be clearly understood by those skilled in the art from the descriptions described above.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

What is claimed is:

1. A see-through optical system for expanding both horizontal and vertical exit pupil distances, the system comprising:
a horizontal light guide having an inclined plane and a reflection plane with a sawtooth structure;
a lens unit for collecting an image light displayed on a display panel and optically enlarging the image light, the lens unit impinging the enlarged image light upon the inclined plane, wherein the enlarged image light propagates within the horizontal light guide bounded by the sawtooth structure based on total reflections to increase an exit pupil distance along a horizontal direction;
a vertical light guide, disposed under the horizontal light guide, receiving the enlarged image from the horizontal light guide, expanding the exit pupil distance along a vertical direction.

2. The optical system according to claim 1, further comprising: a compensation prism integrated with the vertical light guide to make the vertical light guide look like a regular lens, wherein the image light is seen in the vertical light guide while an external scene is also viewed through the vertical light guide.

3. The optical system according to claim 2, wherein the horizontal light guide has another inclined plane at one end thereof, the compensation prism is integrated with the horizontal light guide at the another inclined plane.

4. The optical system according to claim 1, wherein the sawtooth structure includes a plurality of reflection areas, a notch is disposed between two adjacent sawteeth, each of the reflection areas reflects a portion of the enlarged image light towards the vertical light guide.

5. The optical system according to claim 4, wherein a distance c between the two adjacent sawteeth is so defined that part of the enlarged image light is reflected and another part of the enlarged image light is totally reflected and continuously propagated for expansion of the exit pupil distance along the horizontal direction.

6. The optical system according to claim 5, wherein the distance c does not exceed 2 mm which is the minimum size of a pupil.

7. The optical system according to claim 2, wherein the inclined plane of the horizontal light guide is maintained at an angle with respect to the horizontal light guide so that the enlarged image light is projected into the horizontal light guide with the angle, wherein the enlarged image light is caused to propagate within the horizontal light guide by total internal reflections.

8. The optical system according to claim 7, wherein the compensation prism is reflectively coated.

9. The optical system according to claim 8, wherein the sawtooth structure includes a plurality of reflection areas, a notch is disposed between two adjacent sawteeth, each of the reflection areas is reflectively coated.

10. The optical system according to claim 1, wherein an integration of the horizontal light guide, the lens unit and the vertical light guide along with the display panel is used in a wearable display device for a wearer to see simultaneously the enlarged image light in the vertical light guide and view an external scene through the vertical light guide.
